(19) United States
(12) Patent Application Publication
(10) Pub. No.: US 2025/0244354 A1
(43) Pub. Date: Jul. 31, 2025

(54) SYSTEM AND METHOD FOR DETERMINING A TRAILER AXLE COUNT AND LOCATION

(71) Applicant: GM GLOBAL TECHNOLOGY OPERATIONS LLC, Detroit, MI (US)

(72) Inventors: Amin Habibnejad Korayem, Markham (CA); Iman Fadakar, Brampton (CA); Hojjat Izadi, Richmond Hill (CA); Joseph K. Moore, Whitby (CA); Mehdi Abroshan, Waterloo (CA); Henry W. Grasman, Flushing, MI (US); Mohammadali Shahriari, Markham (CA); Zhi Li, Unionville (CA); Ashraf Abualfellat, Grand Blanc, MI (US)

(73) Assignee: GM GLOBAL TECHNOLOGY OPERATIONS LLC, Detroit, MI (US)

(21) Appl. No.: 18/426,566

(22) Filed: Jan. 30, 2024

(51) Int. Cl. G01P 15/00; G07C 5/04

(52) U.S. Cl. CPC G01P 15/00; G07C 5/04

(57) ABSTRACT

A method of determining a trailer axle count and axle location for a trailer relative to a vehicle. The method includes receiving vehicle operating characteristics from at least one sensor on the vehicle and determining if the vehicle encountered a bump on a roadway based on at least one of the vehicle operating characteristics. The method determines if at least one trailer axle encountered the bump and analyzes a relative time difference between when the vehicle encountered the bump and when the at least one trailer axle encountered the bump. The method utilizes the relative time to determine a trailer axle count and estimate a location of the at least one trailer axle relative to the vehicle.

### INTRODUCTION

The present disclosure relates to determining a trailer axle location and, more particularly, to determining a location of the trailer axle relative to a tow vehicle.

A driver of a tow vehicle encounters several obstacles when towing a trailer. Towing a trailer can influence the dynamics of the tow vehicle and lead the driver of the tow vehicle to operate the vehicle in a different manner due to the increase in length the trailer adds to the tow vehicle. Additionally, the trailer can articulate relative to tow vehicle during certain maneuvers, such as during reversing, which requires a change in inputs to the tow vehicle to reverse when compared to reversing without the trailer. Also, the added weight of the trailer can influence the ability of the tow vehicle under braking situations.

### SUMMARY

Disclosed herein is a method of determining a trailer axle count and axle location for a trailer relative to a vehicle. The method includes receiving vehicle operating characteristics from at least one sensor on the vehicle and determining if the vehicle encountered a bump on a roadway based on at least one of the vehicle operating characteristics. The method determines if at least one trailer axle encountered the bump and analyzes a relative time difference between when the vehicle encountered the bump and when the at least one trailer axle encountered the bump. The method utilizes the relative time to determine a trailer axle count and estimate a location of the at least one trailer axle relative to the vehicle.

Another aspect of the disclosure may include determining an enabling excitation of the vehicle when the vehicle encountered the bump and the enabling excitation includes identifying at least one of a steering angle of the vehicle being within a predetermined range, a velocity of the vehicle being greater than a predetermined velocity, or a difference in wheel speed between laterally spaced wheels on the vehicle is less than a predetermined value.

Another aspect of the disclosure may include confirming a presence of the trailer coupled to the vehicle when the location of the at least one trailer axle relative to the vehicle is estimated.

Another aspect of the disclosure may be where the at least one sensor includes at least one of a ride height sensor, a wheel speed sensor, or an inertial measurement unit located on the vehicle. Determining if the vehicle encountered the bump is based on determining an amplitude of a rate of change of the at least one vehicle operating characteristics.

Another aspect of the disclosure may be where the at least one sensor is located on the vehicle and determining if the at least one trailer axle encountered the bump is based on determining an amplitude of a rate of change of the at least one the vehicle operating characteristic within a time frame after the vehicle encountered the bump.

Another aspect of the disclosure may include determining a status of the trailer by determining if the amplitude of the rate of change of the at least one vehicle operating characteristic is located within a predetermined range.

Another aspect of the disclosure may include receiving a second set of vehicle operating characteristics from the at least one sensor on the vehicle and determining if the vehicle encountered a second bump on the roadway based on at least one of the second set of vehicle operating characteristics. The method determines if at least one trailer axle encountered the bump and analyzes a relative time difference between when the vehicle encountered the bump and when the at least one trailer axle encountered the bump to determine a second trailer axle count and estimates a second location of the at least one trailer axle relative to the vehicle. The method identifies a change in operating status of the trailer if a difference between the second location of the at least one trailer axle and the location of the at least one trailer axle exceeds a predetermined threshold.

Another aspect of the disclosure may be where determining if the vehicle encountered the bump includes determining an estimated wheelbase length for the vehicle based on a velocity of the vehicle and a relative time difference between when a front wheel of the vehicle encountered the bump and when a rear wheel of the vehicle encountered the bump.

Another aspect of the disclosure may be where if the estimated wheelbase length is within a predetermined range of a predetermined wheelbase length for the vehicle, then the vehicle has encountered the bump.

Another aspect of the disclosure may be where determining the estimated wheelbase length includes integrating a velocity of the vehicle beginning when one of a pair of front wheels encountered the bump until one of a pair of rear wheels encountered the bump.

Another aspect of the disclosure may be where determining if at least one trailer axle encountered the bump is based on the at least one vehicle sensor being configured to measure when at least one of a longitudinal jerk, a yaw acceleration, or a pitch acceleration exceeds a corresponding predetermined threshold.

Another aspect of the disclosure may be where determining if the at least one trailer axle encountered the bump includes identifying a reduction in oscillation amplitude of at least one of the longitudinal acceleration, the yaw acceleration, or pitch acceleration.

Disclosed herein is a non-transitory computer-readable medium embodying programmed instructions which, when executed by a processor, are operable for performing a method. The method includes receiving vehicle operating characteristics from at least one sensor on the vehicle and determining if the vehicle encountered a bump on a roadway based on at least one of the vehicle operating characteristics. The method determines if at least one trailer axle encountered the bump and analyzes a relative time difference between when the vehicle encountered the bump and when the at least one trailer axle encountered the bump. The method utilizes the relative time to determine a trailer axle count and estimate a location of the at least one trailer axle relative to the vehicle.

Disclosed herein is a vehicle assembly. The vehicle assembly includes a vehicle body with a front axle supported by a front pair of wheels and a rear axle supported by a rear pair of wheels and at least one sensor configured to measure movement of at least one of the front axle, the rear axle, or the vehicle body. The vehicle assembly also includes a controller in electrical communication with the at least one sensor. The controller is configured to receive vehicle operating characteristics from at least one sensor on the vehicle and determine if the vehicle encountered a bump on a roadway based on at least one of the vehicle operating characteristics. The controller is also configured to determine if at least one trailer axle encountered the bump and analyze a relative time difference between when the vehicle encountered the bump and when the at least one trailer axle encountered the bump to estimate at least one of a trailer axle count or a location.

### BRIEF DESCRIPTION OF THE DRAWINGS

FIG. 1 is a schematic diagram of a vehicle system including a vehicle and a trailer.

FIG. 2 illustrates an example method of determining a trailer axle count and location.

FIG. 3 illustrates a graphical representation of a state parameter of the vehicle of FIG. 1 measured over a period time.

FIG. 4A illustrates a graphical representation of a rate of change of a state parameter of FIG. 3 measured over the period of time.

FIG. 4B illustrates a graphical representation of a temporal based analysis amplitude-phase form taken of the rate of change illustrated in FIG. 4 over the period of time.

FIG. 5 illustrates a graphical representation of an estimation of trailer axle location.

FIG. 6 illustrates another example method of determining a trailer axle count and location.

FIG. 7 is a graphical representation of movement of a front axle on the vehicle of FIG. 1.

FIG. 8 is a graphical representation of movement of a rear axle on the vehicle of FIG. 1.

FIG. 9 is a graphical representation of an example of inertial movement of the vehicle of FIG. 1 as two axles on the trailer pass over a speed bump.

FIG. 10 is a graphical representation of an example of determining the trailer axle count.

FIG. 11 is a graphical representation of an example of determining the trailer axle location.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

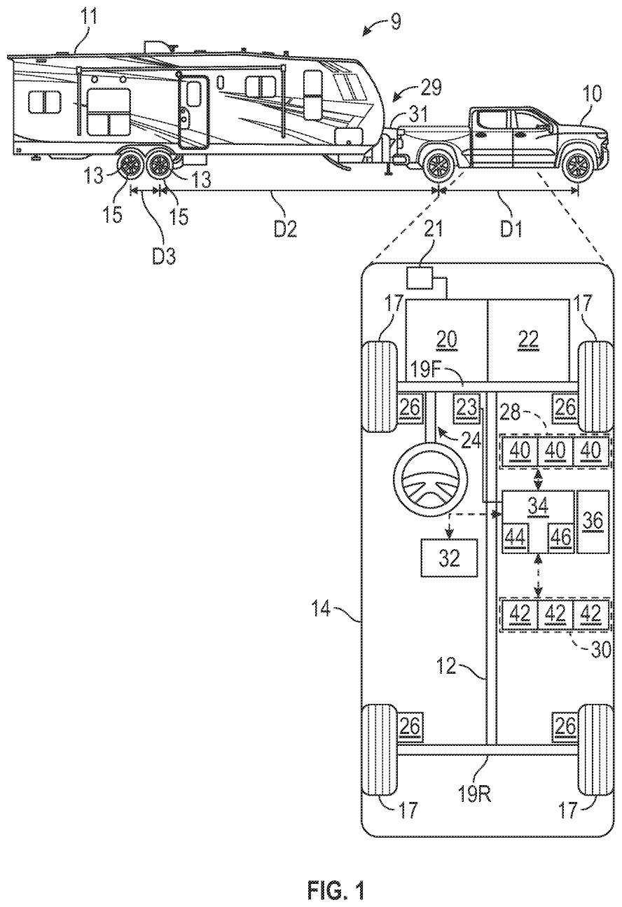

With reference to FIG. 1, the vehicle 10 generally includes a chassis 12, a body 14, front and rear wheels 17. The body 14 is arranged on the chassis 12 and substantially encloses components of the vehicle 10. The body 14 and the chassis 12 may jointly form a frame. The wheels 17 are each rotationally coupled to the chassis 12 near a respective corner of the body 14.

In various embodiments, the vehicle 10 may be an autonomous vehicle. The vehicle 10 is, for example, a vehicle that is automatically controlled to carry passengers from one location to another. The vehicle 10 is depicted in the illustrated embodiment as a pickup truck, but it should be appreciated that other vehicles including sport utility vehicles (SUVs), recreational vehicles (RVs), etc., can also be used.

The vehicle 10 is part of a vehicle system 9. The vehicle system 9 further includes a trailer 11 attached to the vehicle 10. The trailer 11 includes one or more trailer axles 13 each having trailer wheels 15 for supporting the trailer 11.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an electric machine such as a traction motor and/or a fuel cell propulsion system. The vehicle 10 further includes a battery (or battery pack) 21 electrically connected to the propulsion system 20. Accordingly, the battery pack 21 is configured to store electrical energy and to provide electrical energy to the propulsion system 20. Additionally, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously variable transmission, or other appropriate transmission. The brake system 26 is configured to provide braking torque to the vehicle wheels 17. The brake system 26 may, in various embodiments, include friction brakes, brake by wire, a regenerative braking system such as an electric machine, and/or other appropriate braking systems. The steering system 24 influences a position of the vehicle wheels 17. While depicted as including a steering wheel for illustrative purposes, in some embodiments contemplated within the scope of the present disclosure, the steering system 24 may not include a steering wheel.

The vehicle wheels 17 are supported by a front axle 19F and a rear axle 19R. The front and rear axles 19F and 19R are separated by a distance D1 and the rear axle 19R is separated from a front axle on the trailer 11 by a distance D2, and the front and rear trailer axles 13 are separated by a distance D3.

The sensor system 28 includes one or more sensors 40 (i.e., sensing devices) that sense observable conditions of the exterior environment and/or the interior environment of the vehicle 10. The sensors 40 are in communication with the controller 34 and may include, but are not limited to, one or more radars, one or more light detection and ranging (lidar) sensors, one or more ground penetrating radar (GPR) sensors, one or more global positioning systems (GPS) devices, one or more cameras (e.g., optical cameras and/or thermal cameras, such as a rear camera and/or a front camera), brake pedal position sensor, accelerator pedal position sensor, steering angle sensor, speed sensor, wheel speed sensor, ride height sensors, steering angle sensor, ultrasonic sensors, one or more inertial measurement units (IMUs), a trailer connection status sensor, and/or other sensors. The trailer connection status sensor can determine a status of a trailer connection 31, such as an electrical connection, between the vehicle 10 and the trailer 9. The status of the trailer connection 31 can be used to determine a presence of the trailer 9.

The sensor system 28 includes one or more Global Positioning System (GPS) transceiver configured to detect and monitor the route data (i.e., route information). The GPS device is configured to communicate with a GPS to locate the position of the vehicle 10 in the globe. The GPS device is in electronic communication with the controller 34. Because the sensor system 28 provides data to the controller 34, the sensor system 28 and its sensors 40 are considered sources of information (or simply sources).

The actuator system 30 includes one or more actuator devices 42 that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered). For example, the actuator devices 42 include an accelerator pedal, a brake pedal, etc.

The controller 34 includes at least one processor 44 and a non-transitory computer readable storage device or media 46. The processor 44 can be a custom made or commercially available processor, a central processing unit (CPU), a graphics processing unit (GPU), an auxiliary processor among several processors associated with the controller 34, a semiconductor-based microprocessor (in the form of a microchip or chip set), a microprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using a number of other memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a number of controllers 34 that communicate over a suitable communication medium or a combination of communication mediums and that cooperate to process the sensor signals, perform logic, calculations, methods, and/or algorithms, and generate control signals to automatically control features of the vehicle 10.

The vehicle 10 includes a human-machine interface (HMI) 23, which may be a center stack screen or a drive information center. The HMI 23 interacts with a user to show information and receives confirmation, activation, cancellation commands, etc. The HMI 23 may be configured as an alarm, such as a speaker to provide a sound, a haptic feedback in a vehicle seat or other object, a visual display, or other device suitable to provide a notification to the vehicle operator of the vehicle 10. The HMI 23 is in electronic communication with the controller 34 and is configured to receive inputs from a user (e.g., vehicle operator). Accordingly, the controller 34 is configured to receive inputs from the user via the HMI 23. The HMI 23 includes a display configured to display information to the user (e.g., vehicle operator or passenger) and may include one or more speakers to provide an auditable notification to the vehicle operator.

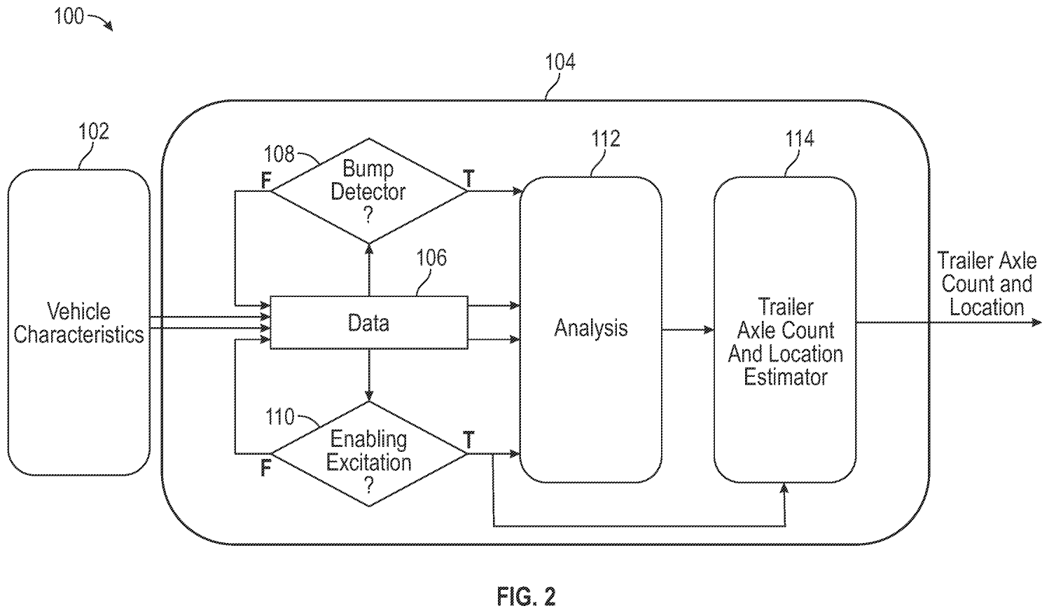

FIG. 2 illustrates a flow diagram of a method 100 for determining a trailer axle count and location relative to the vehicle 10. At Block 102, the method 100 receives vehicle operating characteristics and signals from the sensors 40 on the vehicle 10. In one example, the vehicle operating characteristics are transferred over a controller area network (CAN) bus as CAN messages. The CAN messages include vehicle specific information that can include a suspension height at each corner of the vehicle 10, a wheel to body displacement, a velocity of the vehicle 10, acceleration of the vehicle 10, wheel speed sensor signals at each wheel 17, force on the axles 19F and 19R, wheel torques at each wheel 17, grade of a road surface, steering wheel angle of the vehicle 10, trailer connection status signal to the vehicle 10, output of IMUs of the vehicle 10, ultrasonic sensor signals, camera signals, lidar signals, radar signals, relative time of the occurrence of the above vehicle specific information, etc.

The vehicle operating characteristics from the CAN messages are initially analyzed at Block 104 and stored at Block 106, such as in the media 46 on the vehicle 10. The vehicle operating characteristics stored at Block 106 are utilized at Block 110 to determine if the vehicle 10 has established enabling excitation and at Block 108 to determine if a bump was encountered by the vehicle 10. The bump can include an irregularity in a road surface, such as a speed bump, pot hole, or other change in road surface.

At Block 108, the method 100 determines if the vehicle 10 encountered a bump based on the vehicle operating characteristics from Block 102 that were stored in Block 106. In one example, the method 100 determines if the vehicle 10 encountered a bump by utilizing the ride height sensor to monitor for changes in a ride height of the front and rear axles of the vehicle 10. However, the method 100 can utilize other vehicle operating characteristics from the sensors 40 or multiple vehicle operating characteristics to function as a verification for bump detection.

FIG. 3 is a graphical representation 200 of vehicle ride height captured by at least one of the ride heights sensors that are part of the sensor system 28. In the illustrated example, the graphical representation 200 defines time (t) along the x-axis and a vehicle ride height 202 along the y-axis with a line 204 representing changes in the vehicle ride height over time (t). In the illustrated example, the changes in the vehicle ride height are measured for a single rear wheel 17, however, changes in vehicle ride height can be measured for one or more of the other wheels 17 on the vehicle 10 as well. In the illustrated example, the line 204 includes multiple peaks 206 representing a change in deflection direction corresponding to a time (t). The enlarged region 210 identifies a possible area representing the trailer 11 encountering the bump and the transfer of force through the hitch assembly 29 to the vehicle 10.

As an alternative to measuring vehicle ride height, the graphical representation 200 can include information from sensors 40 such as the wheel speed sensor, one of the IMUs, ultrasonic sensors, cameras, lidars or from another sensor 40 on the vehicle 10 capable of capturing an encounter of the vehicle 10 with the bump and an interaction of the trailer 11 with the vehicle 10 while the trailer 11 encounters the bump.

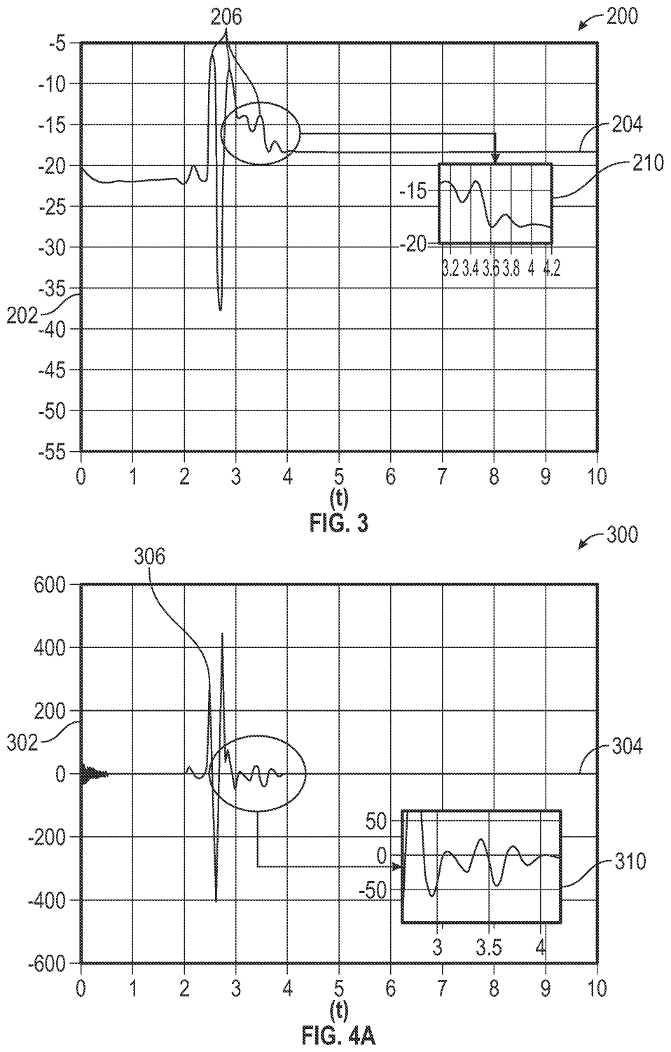

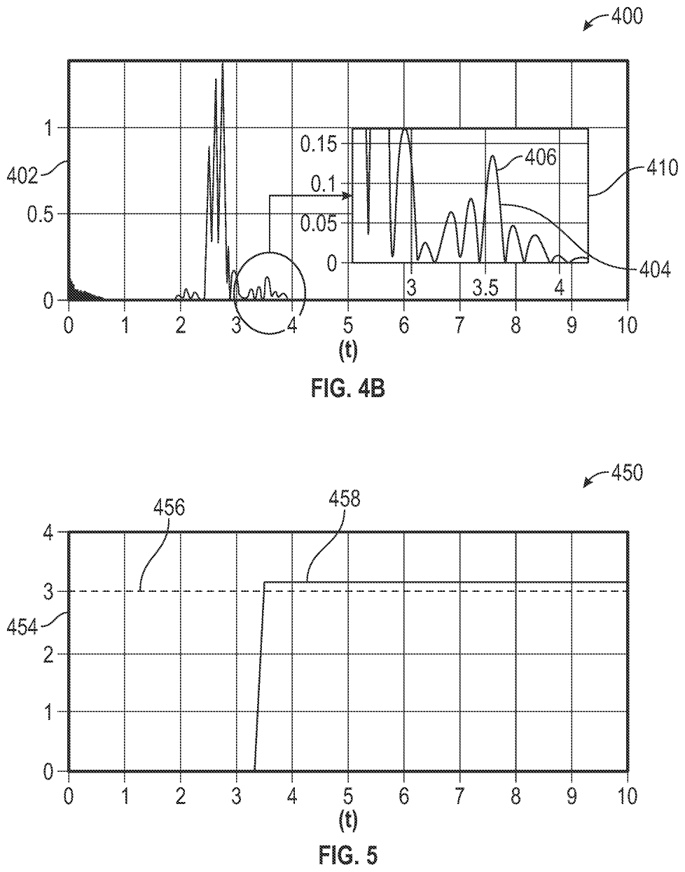

FIG. 4A is a graphical representation 300 of a derivative of the vehicle ride height shown in FIG. 3. The derivative represents a rate of change in the vehicle ride height. The graphical representation 300 defines time (t) along the x-axis and a rate of change 302 in the vehicle ride height along the y-axis with a line 304. In the illustrated example, the rate of change represented by an initial peak 306 can indicate of rate of change in vehicle ride height that corresponds to encountering a bump.

An enlarged region 310 in FIG. 4A represents a period of time (t) where the vehicle ride height sensor captured an interaction of the trailer 11 encountering the bump and transferring that encounter to the vehicle 10 through the hitch assembly 29. While the hitch assembly 29 in the illustrated example of FIG. 1 is shown as a bumper hitch connection, other hitch connections, such as a fifth wheel connection or a goose neck connection, can be used with this disclosure.

To establish the enabling excitation for the vehicle, the method 100 analyzes a set of the vehicle operating characteristics from the sensors 40. The enabling excitation ensures that the vehicle 10 is operating in a manner that will reduce error in calculations being performed to determine the trailer axle count and location as outlined below. In particular, the enabling excitation can ensure that the vehicle 10 and trailer 11 are not moving laterally and that a hitch angle between the vehicle 10 and the trailer 11 is zero or within a predetermined range including or adjacent to zero. In one example, the enabling excitation for the vehicle 10 can include at least one of a yaw acceleration less than a predetermined threshold, a difference in wheel speed between left and right wheels 17 on a common axle 19 being within a predetermined threshold range, a steering wheel angle being less than a predetermined threshold, or a velocity between greater than a predetermined threshold to ensure enough excitation of the system at the occurrence of the road obstacle e.g. bump. The velocity measured by the sensors 40 can vary as well.

Once the method 100 has determined that a bump was detected at Block 108 and confirmed that the vehicle 10 had established the enabling excitation at Block 110, the method 100 proceeds to Block 112 to perform a further analysis of the vehicle operating characteristics. In the illustrated example, a temporal based amplitude-phase form is applied to the rate of change of vehicle ride height shown in FIG. 4A to generate an amplitude based on the rate of change with EQ. 1 below (for example a Fourier series analysis). Furthermore, other temporal based method can be used such as autocorrelation of the vehicle ride height with itself or cross correlation with another signal to identify the temporal position of the trailer interaction with the bump relative to the vehicle interaction with the bump to estimate the trailer axle location.

$${s}_{N} ( x ) = \frac{{A}_{0}}{2} + {\sum }_{n = 1}^{N} {A}_{n} * cos ( \frac{2 π}{P} nx - {φ}_{n} ) \qquad EQ . 1$$

FIG. 4B is a graphical representation 400 of the Fourier series amplitude-phase form applied to the rate of change from FIG. 4A. The graphical representation is shown over time (t) along the x-axis with an output 402 represented along the y-axis. The enlarged view 410 illustrates a maximum amplitude 406 of a line 404. By considering the frequency and wavelength, the location of each of the axles 13 can be extracted at Block 114.

At Block 114, the method 100 utilizes a vehicle longitudinal model, such as the one shown in EQ. 2 below, to determine a location of the each of the trailer axles 13.

$$ϕ = Z \qquad EQ . 2$$

In EQ. 2 above, Z is an output signal and ϕ is a regression signal. The method 100 performs an estimation method by performing a recursive least square as shown in EQS. 3-5 below.

$${\hat{x}}_{k + 1} = {\hat{x}}_{k} + {K}_{k + 1} ( {Z}_{k + 1} - {ϕ}_{k + 1} {\hat{x}}_{k} ) \qquad EQ . 3$$

$${K}_{k + 1} = \frac{{P}_{k} {ϕ}_{k + 1}}{λ + {ϕ}_{k + 1} {P}_{k} {ϕ}_{k + {1}^{′}}} \qquad EQ . 4$$

$${P}_{k + 1} = ( 1 - {K}_{k + 1} {ϕ}_{k + 1} ) {p}_{k} / λ \qquad EQ . 5$$

The method 100 can then output a trailer axle location as shown in the graphical representation 450 of FIG. 5 by analyzing a relative time difference between when the vehicle 10 encountered the bump and when the trailer 11 encountered the bump. The graphical representation 450, time (t) is represented along the x-axis and trailer axle length 454 is presented along the y-axis. In the illustrated example, the trailer axle length is relative to a location on the vehicle 10 and illustrates the location for a single one of the axles 13, however, the method 100 can be used to determine the location of multiple axles 13. Line 456 represents the actual trailer axle length relative to the vehicle 10 and line 458 represents the estimated trailer axle length relative to the vehicle 10 based on the method 100 above. As down in FIG. 1, the trailer axle length can be represented as a combination of the lengths D1, D2, or D3 depending on the particular axle to locate and relative location on the vehicle 10.

One feature of determining the location of the axles on the trailer 9 relative to the vehicle 10 is a positive identification of the trailer 9 coupled to the vehicle 10. Therefore, the method 100 can operate independently of the controller 34 determining the presence of the trailer 9 through the trailer connection 31. Therefore, the method 100 provides a redundant confirmation of the presence of the trailer 9 coupled to the vehicle 10 in the event of a failure in the trailer connection 31.

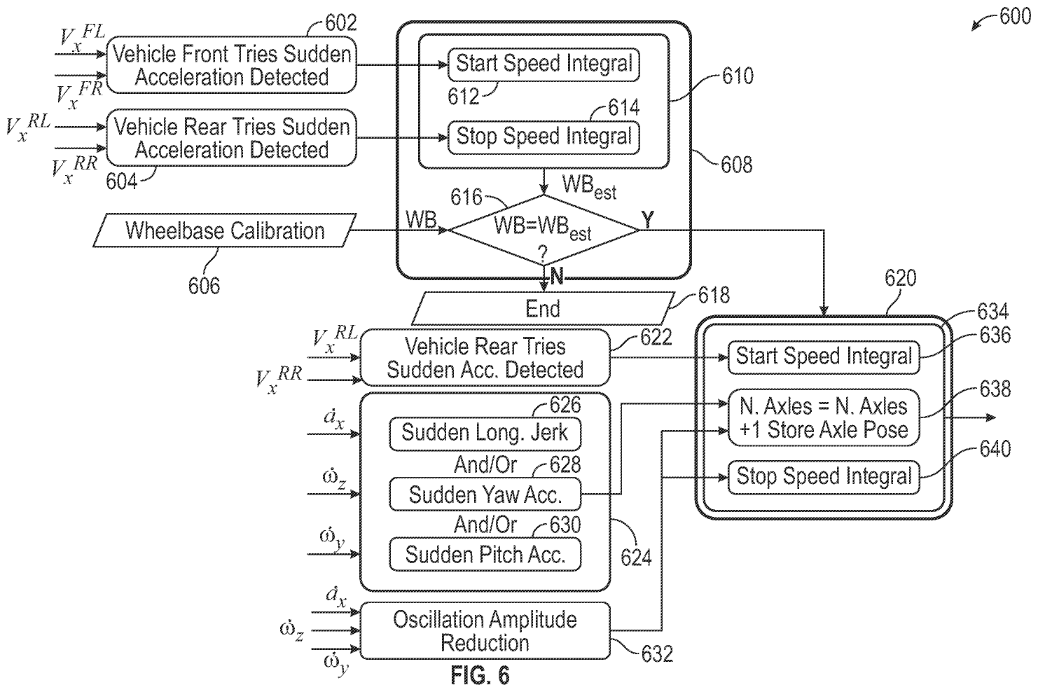

FIG. 6 illustrates another flow diagram of a method 600 for determining a trailer axle count and location relative to the vehicle 10. In the illustrated example, the method 600 receives a velocity of a front left wheel Vₓ^{FL} and a velocity of a front right wheel Vₓ^{FR} at Block 602 and determines if an acceleration in either of the front wheels exceeded a predetermined threshold acceleration. Similarly, the method 600 receives a velocity of a rear left wheel Vₓ^{RL} and a velocity of a rear right wheel Vₓ^{RR} at Block 604 and determines if an acceleration in either of the rear wheels exceeded a predetermined threshold acceleration. If either of the front wheels experienced an acceleration that exceeded the predetermined threshold acceleration, then the method 600 will proceed to Block 608.

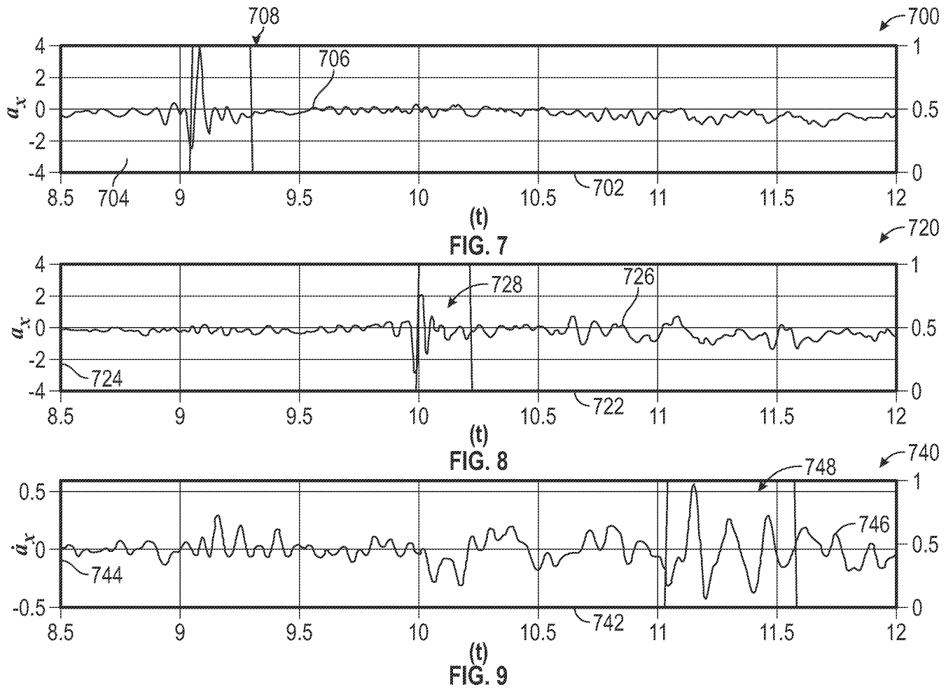

At Block 608, the method 600 performs bump detection. The start of a speed integral is triggered at Block 610 when the acceleration of either of the front wheels exceeded the predetermined threshold as determined at Block 602. FIG. 7 illustrates a graphical representation 700 with line 706 of a longitudinal acceleration ax along the y-axis 704 of one or both of the front wheels on the vehicle 10 over a period of time (t) along the x-axis 702. As shown by the window of time 708 in FIG. 7, at least one of the front wheels of the vehicle 10 encountered a bump on the roadway sufficient to trigger the speed integral at Block 612.

The speed integral stops at Block 614 when the acceleration of one or both of the rear wheels exceeds the predetermined threshold acceleration. FIG. 8 illustrates a graphical representation 720 with line 726 of a longitudinal acceleration a, along the y-axis 724 of one or both of the rear wheels on the vehicle 10 over a period of time (t) along the x-axis 722. As shown by the window of time 728 in FIG. 8, at least one of the rear wheels of the vehicle 10 encountered a bump on the roadway sufficient to stop the speed integral at Block 614. When the speed integral has stopped, the Block 610 outputs an estimated wheelbase length W Bₑₛₜ that is used for bump verification at Block 616.

The bump verification performed at Block 616 compares estimated wheelbase length W Bₑₛₜ with a wheelbase calibration value from Block 606. The wheelbase calibration value represents a measured or predetermined wheelbase length for the vehicle 10. If the estimated wheelbase length W Bₑₛₜ is within a predetermined range or percentage of the wheelbase calibration value, such as the difference being less than or equal to 5%, then the method 600 has determined that a bump was encountered by the vehicle 10 and proceeds to Block 620. If the estimated length W Bₑₛₜ is not within the predetermined range or percentage, the method 600 proceeds to Block 618 and stops determining the trailer axle count and location as wheelbase comparison did not confirm a bump was encountered by the vehicle 10.

At Block 620, the method 600 begins determining the trailer axle count and location relative to the tow vehicle 10 by starting an additional speed integral at Block 634. The start of the speed integral at Block 634 coincides with a time when Block 622 determines that one of the rear wheels on the vehicle 10 experienced a sudden acceleration that exceeded the predetermined threshold acceleration.

Once the speed integral began at Block 636, the method 600 begins to determine the axle count and location relative to the vehicle 10 at Block 638 and 640. The Block 638 receives additional information regarding the vehicle 9 from Block 624 from at least one of the sensors 40 on the vehicle 9, such as an IMU. In the illustrated example, the additional vehicle related information includes a longitudinal jerk \dot{a}r of the vehicle at Block 626, a yaw acceleration \dot{ω}_{z} of the vehicle 9 at Block 628, and a pitch acceleration \dot{ω}_{y} of the vehicle 9 at Block 630. If at least one of the longitudinal jerk \dot{a}ᵣ, the yaw acceleration \dot{ω}_{z}, or the pitch acceleration \dot{ω}_{y} exceeds a corresponding predetermined threshold acceleration, Block 624 sends an indication to Block 638 that at least one of the axles 13 on the trailer 11 encountered a bump. FIG. 9 illustrates a graphical representation 740 of the longitudinal jerk \dot{a}ₓ of the vehicle 9 utilized by Block 626. In the illustrated example, the graphical representation 740 includes time (t) along an x-axis 742 and jerk \dot{a}ₓ along the y-axis 744. A window of time 748 including line 746 represents when the trailer 9 encountered the bump.

Block 638 can note the corresponding time that the bump was encountered. If the trailer 11 continues to encounter any one of the above accelerations/jerk exceeding the corresponding threshold, the method 600 can indicate that the trailer 11 has multiple axles and that a subsequent axle 13 on the trailer 11 has encountered the bump.

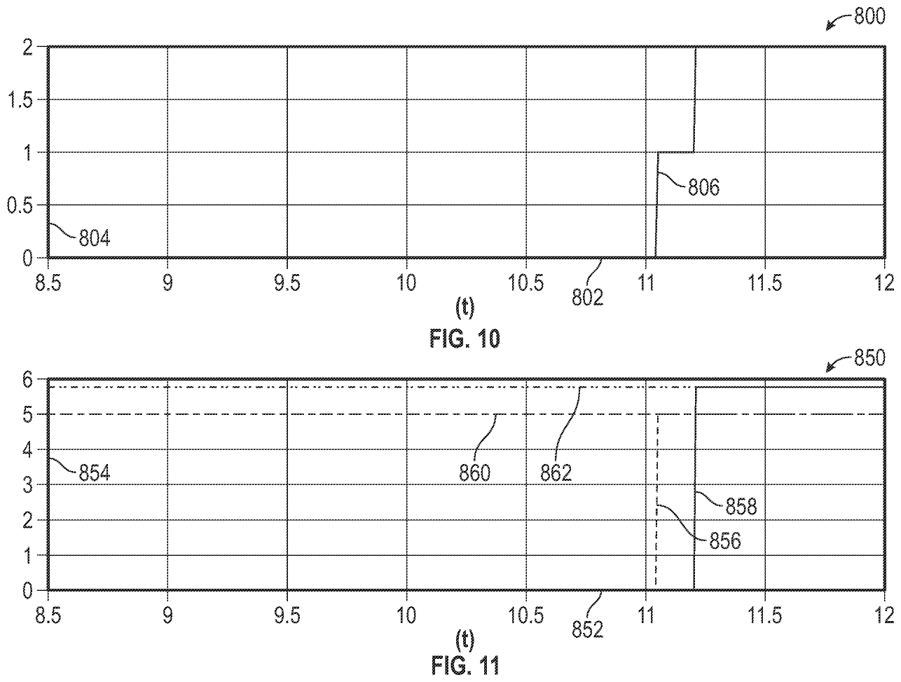

FIG. 10 is a graphical representation 800 of identifying trailer axles with a line 806 with relative time (t) along the x-axis 802 and number of axles identified along the y-axis 804. In the illustrated example of FIG. 10, each step in the line 806 indicates a relative time when the Block 624 identified the trailer 11 encountering one of the accelerations that exceeded the predetermined threshold.

Furthermore, FIG. 11 is a graphical representation 850 of identifying longitudinal positions of the axles 13 with lines 856 and 858 with relative time (t) along the x-axis 852 and longitudinal position along the y-axis 854. The line 856 identifies a first relative time for the speed integral to identify the location of the first axle 13 and line 858 identifies a second relative time for the speed integral to identify the second axle 13. Lines 860 and 862 correspond to actual locations of the axles 13 compared to the estimated locations of the axles.

The method 600 further analyzes the longitudinal jerk \dot{a}ₓ, the yaw acceleration \dot{ω}_{z}, or the pitch acceleration \dot{ω}_{y} at Block 632 to identify a reduction in oscillation amplitude. A reduction in oscillation amplitude in at least one of the longitudinal jerk \dot{a}ₓ, the yaw acceleration \dot{ω}_{z}, or the pitch acceleration \dot{ω}_{y} can indicate that there are no additional axles to be identified on the trailer 11 and that the speed integral from Block 638 should stop. Block 620 can then output the trailer axle count and location based on the relative times of Block 638 receiving the relative times that at least one of the longitudinal jerk \dot{a}ₓ, the yaw acceleration \dot{ω}_{z}, or the pitch acceleration \dot{ω}_{y} exceeded the corresponding predetermined threshold and a reduction in amplitude of one of the accelerations/jerk. The longitudinal jerk is a derivative of the acceleration of the vehicle 9.

With the trailer axle count and location determined by either the method 100 or the method 600 above, this information can be used as input to automatically adjust an automatic trailer break gain modifier. Additionally, when multiple axles are identified, a trailer effective wheelbase estimation can be made from an average of each of the locations of the axles relative to the vehicle 10.

Furthermore, the methods 100 and 600 can continuously recalculate the trailer axle count and location to determine a change in operating status of the trailer 11. For example, if the methods 100 or 600 determines a change in axle count or location beyond a predetermined threshold, the methods 100 and 600 can determine that a status of the trailer 11 has changed. For example, a change in status can indicate that a primary coupling between the vehicle 10 and the trailer 11 has separated or that the attachment needs further adjustments, such as changing an attachment height to the vehicle 10 for leveling the trailer 11.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A method of determining a trailer axle count and axle location for a trailer relative to a vehicle, the method comprising:
receiving a plurality of vehicle operating characteristics from at least one sensor on the vehicle;
determining if the vehicle encountered a bump on a roadway based on at least one of the plurality of vehicle operating characteristics;
determining if at least one trailer axle encountered the bump; and
analyzing a relative time difference between when the vehicle encountered the bump and when the at least one trailer axle encountered the bump to determine a trailer axle count and estimate a location of the at least one trailer axle relative to the vehicle.

2. The method of claim 1, including determining an enabling excitation of the vehicle when the vehicle encountered the bump, wherein determining the enabling excitation includes identifying at least one of a steering angle of the vehicle being within a predetermined range, a velocity of the vehicle being greater than a predetermined velocity, or a difference in wheel speed between laterally spaced wheels on the vehicle is less than a predetermined value.

3. The method of claim 1, including confirming a presence of the trailer coupled to the vehicle when the location of the at least one trailer axle relative to the vehicle is estimated.

4. The method of claim 1, wherein the at least one sensor includes at least one of a ride height sensor, a wheel speed sensor, or an inertial measurement unit located on the vehicle and determining if the vehicle encountered the bump is based on determining an amplitude of a rate of change of the at least one the plurality of vehicle operating characteristics.

5. The method of claim 1, wherein the at least one sensor is located on the vehicle and determining if the at least one trailer axle encountered the bump is based on determining an amplitude of a rate of change of the at least one of the plurality of vehicle operating characteristics within a time frame after the vehicle encountered the bump.

6. The method of claim 5, including determining a status of the trailer by determining if the amplitude of the rate of change of the at least one vehicle operating characteristic is located within a predetermined range.

7. The method of claim 1, including:
receiving a second plurality of vehicle operating characteristics from the at least one sensor on the vehicle;
determining if the vehicle encountered a second bump on the roadway based on at least one of the second plurality of vehicle operating characteristics;
determining if at least one trailer axle encountered the bump;
analyzing a relative time difference between when the vehicle encountered the bump and when the at least one trailer axle encountered the bump to determine a second trailer axle count and estimate a second location of the at least one trailer axle relative to the vehicle; and
determining a change in operating status of the trailer if a difference between the second location of the at least one trailer axle and the location of the at least one trailer axle exceeds a predetermined threshold.

8. The method of claim 1, wherein determining if the vehicle encountered the bump includes determining an estimated wheelbase length for the vehicle based on a velocity of the vehicle and a relative time difference between when a front wheel of the vehicle encountered the bump and when a rear wheel of the vehicle encountered the bump.

9. The method of claim 8, wherein if the estimated wheelbase length is within a predetermined range of a predetermined wheelbase length for the vehicle, then the vehicle has encountered the bump.

10. The method of claim 8, wherein determining the estimated wheelbase length includes integrating a velocity of the vehicle beginning when one of a pair of front wheels encountered the bump until one of a pair of rear wheels encountered the bump.

11. The method of claim 8, wherein determining if at least one trailer axle encountered the bump is based on the at least one vehicle sensor being configured to measure when at least one of a longitudinal jerk, a yaw acceleration, or a pitch acceleration exceeds a corresponding predetermined threshold.

12. The method of claim 11, wherein determining if the at least one trailer axle encountered the bump includes identifying a reduction in oscillation amplitude of at least one of the longitudinal jerk, the yaw acceleration, or pitch acceleration.

13. A non-transitory computer-readable medium embodying programmed instructions which, when executed by a processor, are operable for performing a method comprising:
receiving a plurality of vehicle operating characteristics from at least one sensor on the vehicle;
determining if the vehicle encountered a bump on a roadway based on at least one of the plurality of vehicle operating characteristics;
determining if at least one trailer axle encountered the bump; and
analyzing a relative time difference between when the vehicle encountered the bump and when the at least one trailer axle encountered the bump to estimate at least one of a trailer axle count or a location of the at least one trailer axle relative to the vehicle.

14. The computer-readable medium of claim 13, including determining an enabling excitation of the vehicle when the vehicle encountered the bump, wherein determining the enabling excitation includes identifying at least one of a steering angle of the vehicle being within a predetermined range, a velocity of the vehicle being greater than a predetermined velocity, or a difference in wheel speed between laterally spaced wheels on the vehicle is less than a predetermined value.

15. The computer-readable medium of claim 14, wherein determining if the vehicle encountered the bump is based on determining an amplitude of a rate of change of the at least one the plurality of vehicle operating characteristics and determining if the at least one trailer axle encountered the bump is based on determining an amplitude of a rate of change of the at least one the vehicle operating characteristic within a time frame after the vehicle encountered the bump.

16. The computer-readable medium of claim 13, wherein determining if the vehicle encountered the bump includes determining an estimated wheelbase length for the vehicle based on a velocity of the vehicle and a relative time difference between when a front wheel of the vehicle encountered the bump and when a rear wheel of the vehicle encountered the bump.

17. The computer-readable medium of claim 16, wherein determining if at least one trailer axle encountered the bump is based on the at least one vehicle sensor being configured to measure when at least one of a longitudinal jerk, a yaw acceleration, or a pitch acceleration exceeds a corresponding predetermined threshold; and
wherein determining if the at least one trailer axle encountered the bump includes identifying a reduction in oscillation amplitude of at least one of the longitudinal acceleration, the yaw acceleration, or pitch acceleration.

18. A vehicle assembly comprising:
a vehicle body;
a front axle supported by a front pair of wheels and a rear axle supported by a rear pair of wheels;
at least one sensor configured to measure movement of at least one of the front axle, the rear axle, or the vehicle body;
a controller in electrical communication with the at least one sensor, the controller configured to:
receive a plurality of vehicle operating characteristics from at least one sensor on the vehicle;
determine if the vehicle encountered a bump on a roadway based on at least one of the plurality of vehicle operating characteristics;
determine if at least one trailer axle encountered the bump; and
analyze a relative time difference between when the vehicle encountered the bump and when the at least one trailer axle encountered the bump to estimate at least one of a trailer axle count or a location of the at least one trailer axle relative to the vehicle.

19. The vehicle assembly of claim 18, wherein the at least one sensor is located on the vehicle and determining if the vehicle encountered the bump is based on determining an amplitude of a rate of change of the at least one the plurality of vehicle operating characteristics; and
wherein determining if the at least one trailer axle encountered the bump is based on determining an amplitude of a rate of change of the at least one the vehicle operating characteristic within a time frame after the vehicle encountered the bump.

20. The vehicle assembly of claim 18, wherein determining if the vehicle encountered the bump includes determining an estimated wheelbase length for the vehicle based on a velocity of the vehicle and a relative time difference between when a front wheel of the vehicle encountered the bump and when a rear wheel of the vehicle encountered the bump; and
wherein determining if at least one trailer axle encountered the bump is based on the at least one vehicle sensor being configured to measure when at least one of a longitudinal jerk, a yaw acceleration, or a pitch acceleration exceeds a corresponding predetermined threshold.
